(19) United States
(12) Patent Application Publication
(10) Pub. No.: US 2023/0370163 A1
(43) Pub. Date: Nov. 16, 2023

(54) SIGNAL GENERATION APPARATUS AND METHOD

(71) Applicant: FUJITSU LIMITED, Kawasaki-shi (JP)

(72) Inventors: Jingnan LI, Beijing (CN); Zhenning TAO, Beijing (CN)

(73) Assignee: FUJITSU LIMITED, Kawasaki-shi (JP)

(21) Appl. No.: 18/141,017

(22) Filed: Apr. 28, 2023

(30) Foreign Application Priority Data
May 10, 2022 (CN) 202210502752.2

(51) Int. Cl. H04B 10/073; H04B 10/2543

(52) U.S. Cl. CPC H04B 10/073; H04B 10/2543

(57) ABSTRACT

A signal generation apparatus and method. The apparatus includes: a memory, and a processor coupled to the memory to control execution of a process to: perform dispersion processing on a two-dimensional reference signal to obtain a two-dimensional dispersion signal; perform at least one time of equiprobability processing, perturbation processing and isospectral processing on a two-dimensional input signal according to the two-dimensional dispersion signal; and output a two-dimensional isospectral equiprobability signal generated, when an equiprobability processed signal or an isospectral processed signal satisfies a predetermined condition, wherein in the equiprobability processing. In the equiprobability processing, the two-dimensional dispersion signal and the two-dimensional input signal are classified, so that numbers of constellation points of the two-dimensional input signal and the two-dimensional dispersion signal of same classes are identical, and the classified two-dimensional input signal and two-dimensional dispersion signal are sorted, so that the equiprobability processed signal maintain joint probability distribution.

### CROSS-REFERENCE TO RELATED APPLICATIONS

This application is based on and hereby claims priority to Chinese Application No. 202210502752.2, filed May 10, 2022, in the China National Intellectual Property Administration, the disclosure of which is incorporated herein by reference.

### TECHNICAL FIELD

This disclosure relates to the field of communication technologies.

### BACKGROUND

In a communication system, sometimes, it is needed to generate signals according to requirements on certain frequency spectra and probability density functions (PDFs). For example, in a nonlinear system, nonlinear characteristics of the system are closely related to a frequency spectrum and probability density function of an input signal, hence, it is needed to generate a signal simultaneously satisfying requirements on a specific frequency spectrum and probability density function. In addition, in nonlinear noise measurement, it is needed to remove the frequency components of an input test signal at certain frequency bands, so as to form specific band notch spectrum characteristics. Meanwhile, it is also required that the above band notch process does not change probability density function characteristics of the signal, thereby ensuring that a result of the nonlinear noise measurement is accurate.

Currently, existing technologies can generate signals that only satisfy specific probability distribution requirements, such as rejection sampling. In addition, existing technologies can generate signals that only satisfy specific spectral distribution requirements, such as filtering white noises by using filters with the same frequency response as target spectral distribution.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

According to an aspect of the embodiments of this disclosure, there is provided a signal generation apparatus, the apparatus including: a memory; and a processor coupled to the memory to control execution of a process to: perform dispersion processing on a two-dimensional reference signal to obtain a two-dimensional dispersion signal; perform at least one time of equiprobability processing, perturbation processing and isospectral processing on a two-dimensional input signal according to the two-dimensional dispersion signal; and output a two-dimensional isospectral equiprobability signal generated, when an equiprobability processed signal according to the equiprobability processing or an isospectral processed signal according to the isospectral processing satisfies a predetermined condition, wherein in the equiprobability processing, the two-dimensional dispersion signal and the two-dimensional input signal are classified, so that numbers of constellation points of the two-dimensional input signal and the two-dimensional dispersion signal of same classes are identical, and the classified two-dimensional input signal and two-dimensional dispersion signal are sorted, so that the equiprobability processed signal maintains joint probability distribution.

According to an aspect of the embodiments of this disclosure, there is provided a signal generation apparatus, the apparatus including: a memory; and a processor coupled to the memory to control execution of a process to: perform dispersion processing on a two-dimensional reference signal to obtain a two-dimensional dispersion signal; perform at least one time of equiprobability processing, perturbation processing and isospectral processing on a two-dimensional input signal according to the two-dimensional dispersion signal; and output a two-dimensional isospectral equiprobability signal generated when an equiprobability processed according to the equiprobability processing or an isospectral processed signal according to the isospectral processing satisfies a predetermined condition, wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

According to an aspect of the embodiments of this disclosure, there is provided a measurement apparatus for nonlinear system noises, the apparatus including: a memory; and a processor coupled to the memory to control execution of a process to: acquire two-dimensional isospectral equiprobability signal of a bilateral band notch and two-dimensional isospectral equiprobability signal of a unilateral band notch, the two-dimensional isospectral equiprobability signal of the bilateral band notch and the two-dimensional isospectral equiprobability signal of the unilateral band notch being generated by the signal generation apparatus described herein according to the embodiments of this disclosure; measure a first power-to-noise ratio of the nonlinear system by using the two-dimensional isospectral equiprobability signal of the bilateral band notch; measure a second power-to-noise ratio of the nonlinear system by using the two-dimensional isospectral equiprobability signal of the unilateral band notch; and calculate a power-to-noise ratio of the nonlinear system introduced by IQ imbalance according to the first power-to-noise ratio and the second power-to-noise ratio.

According to an aspect of the embodiments of this disclosure, there is provided an electronic device, including the apparatus described herein according the embodiments of this disclosure.

According to an aspect of the embodiments of this disclosure, there is provided a signal generation method, the method including: performing dispersion processing on a two-dimensional reference signal to obtain a two-dimensional dispersion signal; performing at least one time of equiprobability processing, perturbation processing and isospectral processing on a two-dimensional input signal according to the two-dimensional dispersion signal; and outputting a two-dimensional isospectral equiprobability signal generated, when an equiprobability processed signal according to the equiprobability processing or an isospectral processed signal according to the isospectral processing satisfies a predetermined condition, wherein in the equiprobability processing, the two-dimensional dispersion signal and the two-dimensional input signal are classified, so that numbers of constellation points of the two-dimensional input signal and the two-dimensional dispersion signal of same classes are identical, and the classified two-dimensional input signal and two-dimensional dispersion signal are sorted, so that the equiprobability processed signal maintain joint probability distribution.

According to an aspect of the embodiments of this disclosure, there is provided a signal generation method, the method including: performing dispersion processing on a two-dimensional reference signal to obtain a two-dimensional dispersion signal; performing at least one time of equiprobability processing, perturbation processing and isospectral processing on a two-dimensional input signal according to the two-dimensional dispersion signal; and outputting a two-dimensional isospectral equiprobability signal generated when an equiprobability processed signal according to the equiprobability processing or an isospectral processed signal according to the isospectral processing satisfies a predetermined condition, wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

According to an aspect of the embodiments of this disclosure, there is provided a measurement method for nonlinear system noises, the method including: obtaining a two-dimensional isospectral equiprobability signal of a bilateral band notch and a two-dimensional isospectral equiprobability signal of a unilateral band notch, the two-dimensional isospectral equiprobability signal of the bilateral band notch and the two-dimensional isospectral equiprobability signal of the unilateral band notch being generated in the signal generation method described in the fifth or sixth aspect of the embodiments of this disclosure; measuring a first power-to-noise ratio of the nonlinear system by using the two-dimensional isospectral equiprobability signal of the bilateral band notch; measuring a second power-to-noise ratio of the nonlinear system by using the two-dimensional isospectral equiprobability signal of the unilateral band notch; and calculating a power-to-noise ratio of the nonlinear system introduced by IQ imbalance according to the first power-to-noise ratio and the second power-to-noise ratio.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a signal generation method according to an embodiment this disclosure;

FIG. 2 is a flowchart of the signal generation method according to an embodiment of this disclosure;

FIG. 3 is another flowchart of the signal generation method according to an embodiment of this disclosure;

FIG. 4 is a schematic diagram of an equiprobability processing method according to an embodiment of this disclosure;

FIG. 5 is a schematic diagram of a method for executing operation 401 according to an embodiment of this disclosure;

FIG. 6 is a schematic diagram of classification based on a constellation of a two-dimensional dispersion signal according to an embodiment of this disclosure;

FIG. 7 is a schematic diagram of classification based on a constellation of a two-dimensional input signal according to an embodiment of this disclosure;

FIG. 8 is another schematic diagram of the classification based on a constellation of a two-dimensional dispersion signal according to an embodiment of this disclosure;

FIG. 9 is another schematic diagram of the classification based on a constellation of a two-dimensional input signal according to an embodiment of this disclosure;

FIG. 10 is a further schematic diagram of the classification based on a constellation of a two-dimensional dispersion signal according to an embodiment of this disclosure;

FIG. 11 is a further schematic diagram of the classification based on a constellation of a two-dimensional input signal according to an embodiment of this disclosure;

FIG. 12 is another schematic diagram of the equiprobability processing method according to an embodiment of this disclosure;

FIG. 13 is a schematic diagram of a perturbation processing method according to an embodiment of this disclosure;

FIG. 14 is a schematic diagram of an isospectral processing method according to an embodiment of this disclosure;

FIG. 15 is schematic diagram of the signal generation method according to an embodiment of this disclosure;

FIG. 16 is a schematic diagram of an equiprobability processing method according to an embodiment of this disclosure;

FIG. 17 is another schematic diagram of the equiprobability processing method according to an embodiment of this disclosure;

FIG. 18 is a schematic diagram of the measurement method for nonlinear system noises according to an embodiment of this disclosure;

FIG. 19 is a schematic diagram of a power spectrum of a signal of a bilateral band notch after passing through a nonlinear system according to an embodiment of this disclosure;

FIG. 20 is a schematic diagram of a power spectrum of a signal of a unilateral band notch after passing through the nonlinear system according to an embodiment of this disclosure;

FIG. 21 is a schematic diagram of a power spectrum of a signal of a unilateral band notch after passing through the nonlinear system in a case where a nonlinear effect occurs after carrier modulation according to an embodiment of this disclosure;

FIG. 22 is a schematic diagram of the signal generation apparatus according to an embodiment of this disclosure;

FIG. 23 is a schematic diagram of the signal generation apparatus according to an embodiment of this disclosure;

FIG. 24 is a schematic diagram of the measurement apparatus for nonlinear system noises according to an embodiment of this disclosure;

FIG. 25 is a schematic diagram of the electronic device according to an embodiment of this disclosure; and

FIG. 26 is a block diagram of a systematic structure of the electronic device according to an embodiment of this disclosure.

### DETAILED DESCRIPTION

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

It was found by the inventors that the existing methods described above usually process one-dimensional signals, such as one-path real signals. In communication systems, it is often needed to use signals of higher dimensions, such as two-dimensional I+jQ (in phase and quadrature) signals. In such a scenario, it is needed that both an I-path signal and a Q-path signal satisfy a specific probability density function and have joint spectral distribution. However, the existing methods cannot provide two-dimensional signals that satisfy the above requirements.

In order to solve at least one of the above problems, embodiments of this disclosure provide a signal generation apparatus and method, in which two-dimensional signals may be processed, both an I-path signal and a Q-path signal satisfy a specific probability density function, and satisfy joint spectral distribution, that is, two-dimensional signals satisfying a specific probability density function and joint spectral distribution may be provided.

An advantage of the embodiments of this disclosure exists in that:

at least one time of equiprobability processing, perturbation processing and isospectral processing is performed on a two-dimensional input signal according to the two-dimensional dispersion signal, and in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintains joint probability distribution. In this way, both the I-path signal and the Q-path signal have specific probability distribution, and the correlation between the I-path signal and the Q-path signal may be kept, thereby obtaining a two-dimensional isospectral equiprobability signal satisfying the required joint probability distribution and joint probability density function, and the method is applicable to various scenarios.

Or, in the equiprobability processing, the two-dimensional dispersion signal and the two-dimensional input signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal. In this way, a two-dimensional isospectral equiprobability signal having I-path signal and Q-path signal with specific probability distribution and having joint probability distribution may be obtained.

Furthermore, by using the two-dimensional isospectral equiprobability signal of a bilateral band notch and two-dimensional isospectral equiprobability signal of a unilateral band notch obtained in the above methods, the first power-to-noise ratio and the second power-to-noise ratio of the nonlinear system may be respectively measured, thereby calculating the power-to-noise ratio of the nonlinear system introduced by IQ imbalance. As the two-dimensional isospectral equiprobability signal of a bilateral band notch and two-dimensional isospectral equiprobability signal of a unilateral band notch obtained in the above methods are two-dimensional isospectral equiprobability signals having I-path signal and Q-path signal with specific probability distribution and having joint probability distribution, the power-to-noise ratios of the nonlinear system measured thereby are relatively high in accuracy.

### Embodiment 1

The embodiment of this disclosure provides a signal generation method.

In some embodiments, the signal generation method may be applied to an input end of a communication system or a nonlinear system.

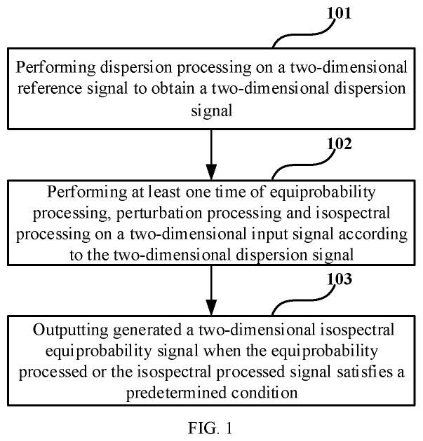

FIG. 1 is schematic diagram of the signal generation method of Embodiment 1 of this disclosure. As shown in FIG. 1, the method includes:

operation 101: performing dispersion processing on a two-dimensional reference signal to obtain a two-dimensional dispersion signal;

operation 102: performing at least one time of equiprobability processing, perturbation processing and isospectral processing on a two-dimensional input signal according to the two-dimensional dispersion signal; and

operation 103: outputting generated a two-dimensional isospectral equiprobability signal when the equiprobability processed or the isospectral processed signal satisfies a predetermined condition,

wherein in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution.

In this way, both the I-path signal and the Q-path signal have specific probability distribution, and the correlation between the I-path signal and the Q-path signal may be kept, thereby obtaining a two-dimensional isospectral equiprobability signal satisfying the required joint probability distribution and joint probability density function, and the method is applicable to various scenarios.

In some embodiments, the performing at least one time of equiprobability processing, perturbation processing and isospectral processing on a two-dimensional input signal refers to performing at least one time of equiprobability processing, perturbation processing and isospectral processing on the two-dimensional input signal, that is, the equiprobability processing, perturbation processing and isospectral processing is performed in an iterative manner, and the iteration is stopped and a signal is outputted until a predetermined condition is satisfied. In other words, an iterative process includes one time of equiprobability processing, one time of perturbation processing and one time of isospectral processing.

In some embodiments, after one time of iteration, that is, after one time of equiprobability processing, perturbation processing and isospectral processing, whether the predetermined condition is satisfied is determined after isospectral processing in a next iteration process, if the predetermined condition is satisfied, the signal is outputted, and if the predetermined condition is not satisfied, the next iteration process is proceeded.

In some embodiments, after one time of iteration, that is, after one time of equiprobability processing, perturbation processing and isospectral processing, whether the predetermined condition is satisfied may be determined after the isospectral processing, or after equiprobability processing in the next iteration process, if the predetermined condition is satisfied, the signal is outputted, and if the predetermined condition is not satisfied, remaining processing in this time of iteration is continued and the next iteration process is proceeded.

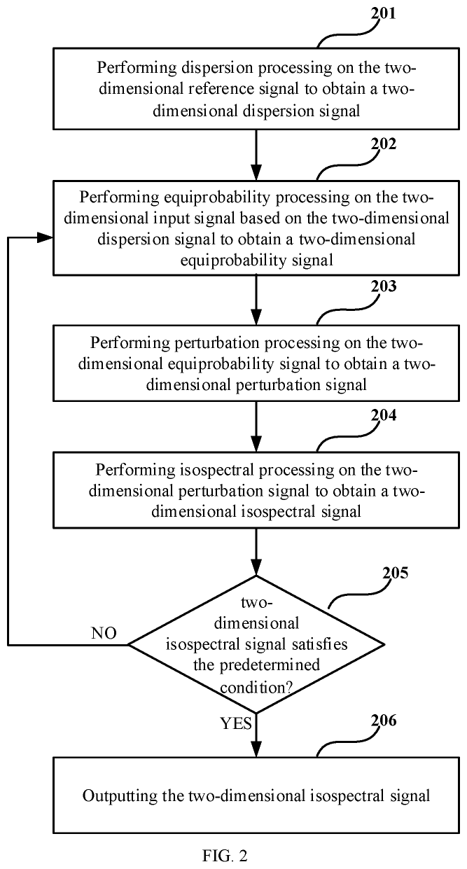

FIG. 2 is a flowchart of the signal generation method of Embodiment 1 of this disclosure. As shown in FIG. 2, the method includes:

operation 201: performing dispersion processing on the two-dimensional reference signal to obtain a two-dimensional dispersion signal;

operation 202: performing equiprobability processing on the two-dimensional input signal based on the two-dimensional dispersion signal to obtain a two-dimensional equiprobability signal;

operation 203: performing perturbation processing on the two-dimensional equiprobability signal to obtain a two-dimensional perturbation signal;

operation 204: performing isospectral processing on the two-dimensional perturbation signal to obtain a two-dimensional isospectral signal;

operation 205: judging whether the two-dimensional isospectral signal satisfies the predetermined condition, proceeding to operation 206 when a result of judgment is “yes”, and turning back to operation 202 when the result of judgment is “no”; and

operation 206: outputting the two-dimensional isospectral signal; as equiprobability processing has been performed previously, the two-dimensional isospectral signal is a two-dimensional isospectral equiprobability signal.

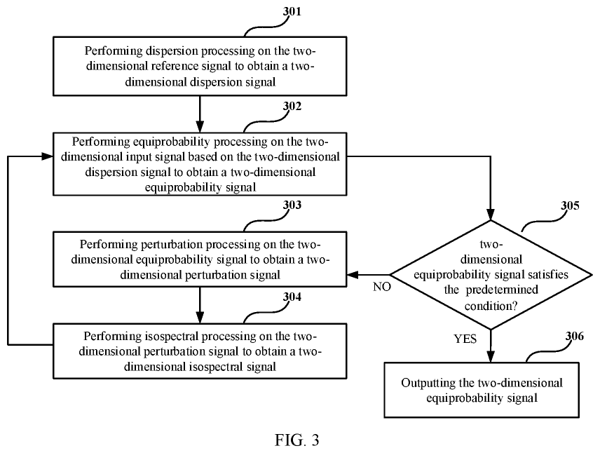

FIG. 3 is another flowchart of the signal generation method of Embodiment 1 of this disclosure. As shown in FIG. 3, the method includes:

operation 301: performing dispersion processing on the two-dimensional reference signal to obtain a two-dimensional dispersion signal;

operation 302: performing equiprobability processing on the two-dimensional input signal based on the two-dimensional dispersion signal to obtain a two-dimensional equiprobability signal;

operation 303: performing perturbation processing on the two-dimensional equiprobability signal to obtain a two-dimensional perturbation signal;

operation 304: performing isospectral processing on the two-dimensional perturbation signal to obtain a two-dimensional isospectral signal;

turning back to operation 302 and performing equiprobability processing on the two-dimensional isospectral signal again to obtain a two-dimensional equiprobability signal;

operation 305: judging whether the two-dimensional equiprobability signal satisfies the predetermined condition, proceeding to operation 306 when a result of judgment is “yes”, and turning back to operation 303 when the result of judgment is “no”; and

operation 306: outputting the two-dimensional equiprobability signal; as isospectral processing has been performed previously, the two-dimensional equiprobability signal is a two-dimensional isospectral equiprobability signal.

In some embodiments, the two-dimensional reference signal and the two-dimensional input signal refer to complex signals including I-path and Q-path signals, that is, I+jQ.

In some embodiments, the two-dimensional reference signal provides target probability distribution.

In some embodiments, the predetermined condition for completing the iteration may be set according to an actual situation.

In some embodiments, the predetermined condition for completing the iteration is that a difference between the two-dimensional signal and the two-dimensional reference signal after equiprobability processing or isospectral processing is less than a predetermined threshold. For example, a difference between the probability distribution of the two-dimensional signal after equiprobability processing or isospectral processing and target probability distribution provided by the two-dimensional reference signal is less than the predetermined threshold.

In some embodiments, the two-dimensional reference signal is expressed as:

S_{Ref}=S_{I}+jS_{Q} (1);

where, S_{Ref}, S_{I} and S_{Q} are the reference signal, I-path reference signal and the Q-path reference signal, respectively, and j is an imaginary unit.

In some embodiments, the probability distribution of the two-dimensional reference signal satisfies the above requirement for target probability distribution, or, the target probability distribution is provided by the two-dimensional reference signal, or, the target probability distribution is given in a form of a two-dimensional reference signal, or the probability distribution of the two-dimensional reference signal is identical to the target probability distribution. Therefore, a finally-obtained two-dimensional signal is made to conform to the requirement for the target probability distribution.

In some embodiments, the dispersion processing converts a discrete two-dimensional reference signal into a distributed contiguous two-dimensional dispersion signal. For example, the dispersion processing may be expressed as:

S_{d}=S_{ref}+δ_{d}=(S_{I}+jS_{Q})+δ_{I}+jδ_{Q}) (2);

where, S_{d} and δ_{d} respectively denote the two-dimensional dispersion signal and a dispersion amount, S_{Ref} is the reference signal, δ_{I} and δ_{Q} respectively denote an I-path dispersion amount and a Q-path dispersion amount.

In some embodiments, the I-path dispersion amount and the Q-path dispersion amount may be arbitrary zero-mean contiguously-distributed variables, and their magnitude are denoted by their standard deviations, std(δ_{I}) and std(δ_{Q}).

In some embodiments, the dispersion amount distribution is two-dimensional Gaussian distribution, and furthermore, two-dimensional uniform distribution or other types of distribution may also be used, which are not limited in the embodiment of this disclosure.

In some embodiments, a magnitude of the dispersion amount (i.e., a standard deviation) may be determined based on actual situations.

For example, one way of dispersion processing is to gradually reduce the magnitude of the dispersion amount during the iteration, that is, parameters of the dispersion processing may be variable. As the iterative process progresses, the dispersion amount contained in the two-dimensional dispersion signal gradually decreases, thereby making the probability density function of the finally-obtained two-dimensional signal identical to that of a two-dimensional dispersion signal with a small dispersion amount, and thus closer to a probability density function of an original discrete two-dimensional reference signal.

In some embodiments, the two-dimensional input signal is also referred to as a two-dimensional seed signal.

For example, the two-dimensional input signal may be expressed as:

E_{Seed}=Eₗ+jE_{q} (3);

where, E_{Seed}, E_{I} and E_{Q} are the two-dimensional seed signal, an I-path seed signal and a Q-path seed signal, respectively, and j is an imaginary unit.

In some embodiments, the I-path seed signal and the Q-path seed signal may be random white noise signals, or may be multi-tone signals with equal amplitudes and random phases, or may be other types of signals.

In some embodiments, the two-dimensional seed signal may have various probability distributions. For example, the probability distribution of the two-dimensional seed signal may be two-dimensional Gaussian distribution, two-dimensional uniform distribution, or may be other types of distributions. In addition, the I-path seed signal and the Q-path seed signal are independent of each other.

The equiprobability processing, perturbation processing, and isospectral processing shall be described below in detail.

In the equiprobability processing, the two-dimensional dispersion signal and the two-dimensional input signal are classified to make the numbers of constellation points of the same type of two-dimensional input signals and two-dimensional dispersion signals to be identical, and the classified two-dimensional input signals and two-dimensional dispersion signals are sorted to make the equiprobability processed signals maintain joint probability distribution.

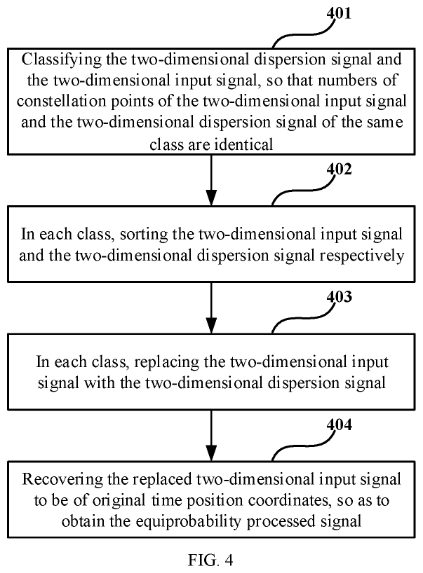

FIG. 4 is a schematic diagram of an equiprobability processing method of Embodiment 1 of this disclosure. As shown in FIG. 4, the method includes:

operation 401: classifying the two-dimensional dispersion signal and the two-dimensional input signal, so that numbers of constellation points of the two-dimensional input signal and the two-dimensional dispersion signal of the same class are identical;

operation 402: in each class, sorting the two-dimensional input signal and the two-dimensional dispersion signal respectively;

operation 403: in each class, replacing the two-dimensional input signal with the two-dimensional dispersion signal; and

operation 404: recovering the replaced two-dimensional input signal to be of original time position coordinates, so as to obtain the equiprobability processed signal.

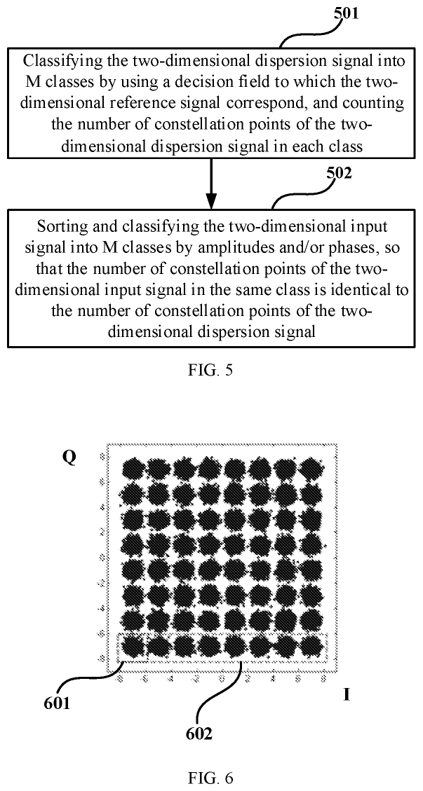

FIG. 5 is a schematic diagram of a method for executing operation 401 of Embodiment 1 of this disclosure. As shown in FIG. 5, the method includes:

operation 501: classifying the two-dimensional dispersion signal into M classes by using a decision field to which the two-dimensional reference signal correspond, and counting the number of constellation points of the two-dimensional dispersion signal in each class; and

operation 502: sorting and classifying the two-dimensional input signal into M classes by amplitudes and/or phases, so that the number of constellation points of the two-dimensional input signal in the same class is identical to the number of constellation points of the two-dimensional dispersion signal;

where, M is a positive integer.

In some embodiments, the two-dimensional dispersion signal and the two-dimensional input signal may be classified based on a modulation format of the two-dimensional reference signal. For example, the two-dimensional dispersion signal and the two-dimensional input signal may be classified based on characteristics of a shape of the constellation of the two-dimensional reference signal.

Following description shall be given by way of specific examples.

For example, when the two-dimensional reference signal is a 64QAM signal, its constellation is square. Accordingly, a constellation of the two-dimensional dispersion signal generated based on the two-dimensional reference signal is also square. In this case, classification may be performed based on the amplitude.

FIG. 6 is a schematic diagram of the classification based on the constellation of the two-dimensional dispersion signal of Embodiment 1 of this disclosure, and FIG. 7 is a schematic diagram of the classification based on the constellation of the two-dimensional input signal of Embodiment 1 of this disclosure.

As shown in FIGS. 6 and 7, the classification method includes:

dividing the two-dimensional dispersion signals into 64 small classes by using a two-dimensional decision domain corresponding to the two-dimensional reference signal, and counting the number of constellation points of the two-dimensional dispersion signals in each small class; for example, square area 601 in FIG. 6 shows a small class;

dividing the two-dimensional dispersion signals into 8 large classes by using a one-dimensional decision domain corresponding to the Q-path signal in the two-dimensional reference signal, and counting the number of constellation points of the two-dimensional dispersion signals in each large class; for example, square area 602 in FIG. 6 shows a large class, the large class including 8 small classes containing the small class denoted by the square area 601;

sorting and classifying the two-dimensional input signal into 8 large classes by amplitudes of its Q-path signals, so that the number of constellation points of the two-dimensional input signal in the same large class is identical to the number of constellation points of the two-dimensional dispersion signal; for example, a rectangular region 702 in FIG. 7 shows a large class, that is, the number of constellation points in the rectangular region 702 is made to be identical to the number of constellation points in the rectangular region 602; and

in each large class, sorting and classifying the two-dimensional input signal into 8 small classes by amplitudes of its I-path signals, so that the number of constellation points of the two-dimensional input signal in the same small class is identical to the number of constellation points of the two-dimensional dispersion signal; for example, the square region 701 in FIG. 7 shows a small class, that is, the number of constellation points in the square region 701 is made to be identical to the number of constellation points in the square region 601.

After the classification is completed, in operation 402, in each small class, the two-dimensional input signals and the two-dimensional dispersion signals are sorted; and in operation 403, in each small class, the two-dimensional input signals are replaced with the two-dimensional dispersion signals.

For example, when the two-dimensional reference signal is an 8PSK signal, its constellation diagram is circular. Accordingly, a constellation of the two-dimensional dispersion signal generated based on the two-dimensional reference signal is also circular. In this case, the classification may be performed based on phases.

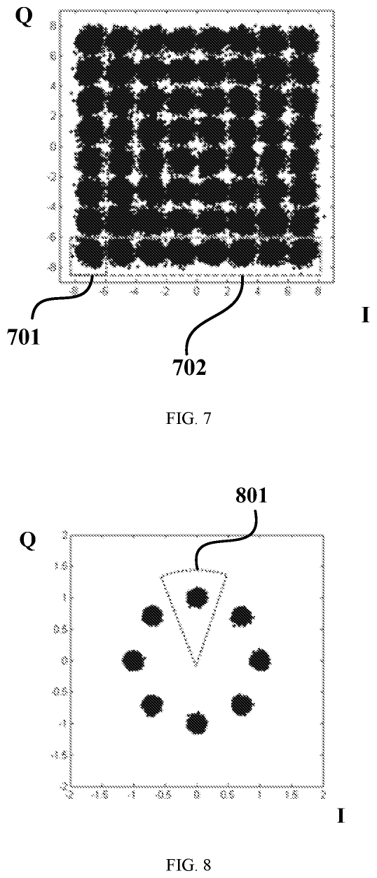

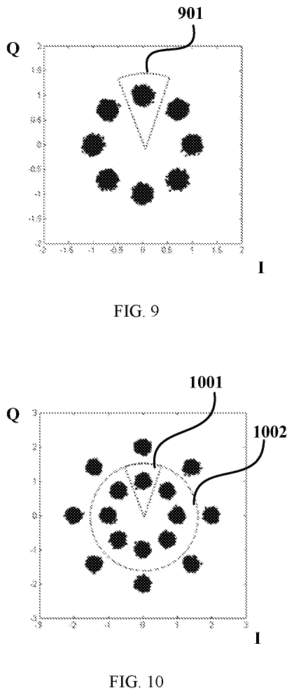

FIG. 8 is another schematic diagram of the classification based on the constellation of the two-dimensional dispersion signal of Embodiment 1 of this disclosure, and FIG. 9 is another schematic diagram of the classification based on the constellation of the two-dimensional input signal of Embodiment 1 of this disclosure.

As shown in FIGS. 8 and 9, the classification method includes:

dividing the two-dimensional dispersion signals into 8 classes by using a decision domain corresponding to the two-dimensional reference signal, and counting the number of constellation points of the two-dimensional dispersion signals in each class; for example, a sector region 801 in FIG. 8 denotes a class;

sorting and dividing the two-dimensional input signals into 8 classes by phases, so that the number of constellation points of the two-dimensional input signals in the same class is identical to the number of constellation points of the two-dimensional dispersion signals; for example, a sector region 901 in FIG. 9 denotes a class, so that the number of constellation points in the sector region 901 is identical to the number of constellation points in the sector region 801.

For example, when the two-dimensional reference signal is a 2A8PSK (8PSK of two amplitudes) signal, its constellation is of two inner and outer rings (with different amplitudes). Accordingly, a constellation of the two-dimensional dispersion signal generated based on the two-dimensional reference signal also has two inner and outer rings. In this case, classification may be performed based on amplitudes and phases.

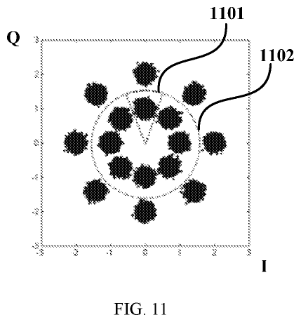

FIG. 10 is a further schematic diagram of the classification based on the constellation of the two-dimensional dispersion signal of Embodiment 1 of this disclosure, and FIG. 11 is a further schematic diagram of the classification based on the constellation of the two-dimensional input signal of Embodiment 1 of this disclosure.

As shown in FIGS. 10 and 11, the classification method includes:

dividing the two-dimensional dispersion signals into 16 small classes by using a two-dimensional decision domain corresponding to the two-dimensional reference signal, and counting the number of constellation points of the two-dimensional dispersion signals in each small class; for example, a sector region 1001 in FIG. 10 shows a small class;

dividing the two-dimensional dispersion signals into 2 large classes by using a one-dimensional decision domain corresponding to the Q-path signal in the two-dimensional reference signal, and counting the number of constellation points of the two-dimensional dispersion signals in each large class; for example, a circular region 1002 of an inner circle in FIG. 10 shows a large class, the large class including 8 small classes containing the small class denoted by the sector region 1001;

sorting and dividing the two-dimensional input signals into 2 large classes according to their amplitudes, so that the number of constellation points of the two-dimensional input signals in the same large class is identical to the number of constellation points of the two-dimensional dispersion signals; for example, a circular region 1102 in an inner circle of FIG. 11 shows a large class, that is, the number of constellation points in the circular region 1102 is made identical to the number of constellation points in the circular region 1002; and

in each large class, sorting and dividing the two-dimensional input signals into 8 small classes according to their phases, so that the number of constellation points of the two-dimensional input signals in the same small class is identical to the number of constellation points of the two-dimensional dispersion signals; for example, a sector region 1101 in FIG. 11 shows a small class, that is, the number of constellation points in the sector region 1101 is made identical to the number of constellation points in the sector region 1001.

Some examples of classification based on the characteristics of the modulation formats of the two-dimensional reference signals, i.e., constellation shapes, are given above. However, this disclosure is not limited to these examples, and the signal processing method of the embodiment of this disclosure is also applicable to signals of other modulation formats (other constellation shapes).

Hence, the above classification method and the signal generation method including the classification method are applicable to various scenarios of probability forming and geometric forming, etc.

After the classification in operation 401 is completed, operation 402 is executed, that is, in each class, the two-dimensional input signals and the two-dimensional dispersion signals are sorted respectively.

In some embodiments, the two-dimensional input signals and two-dimensional dispersion signals are sorted by modulo values, or, the two-dimensional input signals and the two-dimensional dispersion signals are sorted respectively by angles.

After the sorting is completed, operation 403 is executed, that is, in each class, the two-dimensional input signals are replaced with the two-dimensional dispersion signals.

In some embodiments, the two-dimensional input signals are directly replaced with the two-dimensional dispersion signals, or, the two-dimensional input signals are replaced one by one with the two-dimensional dispersion signals by using a minimum Euclidean distance as a criterion.

After the replacement is completed, operation 404 is executed, that is, the replaced two-dimensional input signals are recovered to be of original time position coordinates, so as to obtain the equiprobability processed signals.

In some embodiments, for a case where a training sequence and a pilot symbol are inserted into the two-dimensional reference signal, time position locking is performed before the classifying processing.

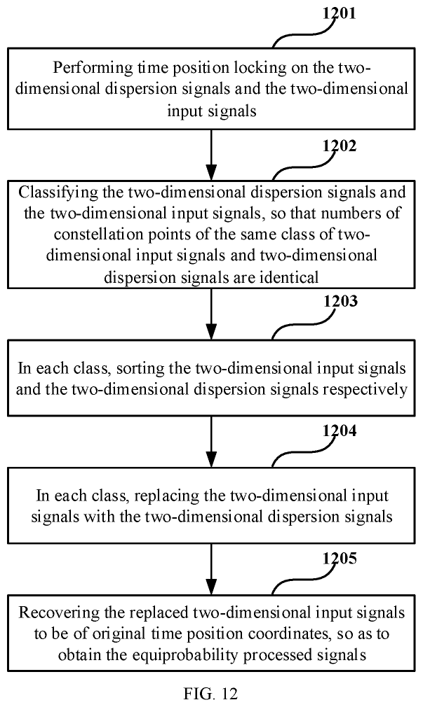

FIG. 12 is another schematic diagram of the equiprobability processing method of Embodiment 1 of this disclosure. As shown in FIG. 12, the method includes:

operation 1201: performing time position locking on the two-dimensional dispersion signals and the two-dimensional input signals; wherein by locking data samples (pilot symbols or training sequences) located at specific time positions in the two-dimensional input signals and the two-dimensional reference signals, it may be ensured that specific pilot symbols or training sequences are at these specific time positions;

operation 1202: classifying the two-dimensional dispersion signals and the two-dimensional input signals, so that numbers of constellation points of the same class of two-dimensional input signals and two-dimensional dispersion signals are identical;

operation 1203: in each class, sorting the two-dimensional input signals and the two-dimensional dispersion signals respectively;

operation 1204: in each class, replacing the two-dimensional input signals with the two-dimensional dispersion signals; and

operation 1205: recovering the replaced two-dimensional input signals to be of original time position coordinates, so as to obtain the equiprobability processed signals.

The equiprobability processing in operations 102, 202 and 302 are described above in detail. After the equiprobability processing, the two-dimensional equiprobability signals are obtained.

After the equiprobability processing is completed, perturbation processing is performed on the two-dimensional equiprobability signals.

The perturbation processing refers to processing that make a fine structure of a spectrum of an input signal within a resolution bandwidth changed randomly. In some embodiments, the perturbation processing is processing a spectrum of a two-dimensional equiprobability signal, and similar to dispersion processing, a perturbation amplitude a of the perturbation processing is variable.

For example, a perturbation amplitude of current perturbation processing decreases in comparison with previous perturbation processing, that is, as an iterative process proceeds, the perturbation amplitude gradually decreases, which makes a probability density function of a finally-obtained two-dimensional isospectral equiprobability signal identical to that of a two-dimensional dispersion signal with a small dispersion amount, and thus closer to a two-dimensional reference signal.

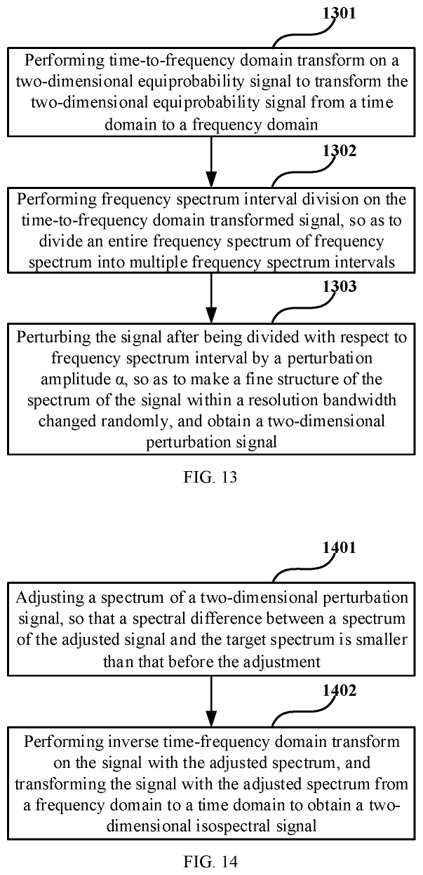

FIG. 13 is a schematic diagram of a perturbation processing method of Embodiment 1 of this disclosure. As shown in FIG. 13, the method includes:

operation 1301: performing time-to-frequency domain transform on a two-dimensional equiprobability signal to transform the two-dimensional equiprobability signal from a time domain to a frequency domain;

operation 1302: performing frequency spectrum interval division on the time-to-frequency domain transformed signal, so as to divide an entire frequency spectrum of frequency spectrum into multiple frequency spectrum intervals; and

operation 1303: perturbing the signal after being divided with respect to frequency spectrum interval by a perturbation amplitude a, so as to make a fine structure of the spectrum of the signal within a resolution bandwidth changed randomly, and obtain a two-dimensional perturbation signal.

After the perturbation processing is completed, isospectral processing is performed.

Power distribution of the spectrum of the signal after isospectral processing is close to power distribution of a target spectrum. In some embodiments, the isospectral processing is processing of a spectrum of a two-dimensional signal, the isospectral processing including unilateral isospectral processing and bilateral isospectral processing. That is, not only may bilateral isospectral processing be realized, such as generating an isospectral signal of a dual side notch, but also may achieve unilateral isospectral processing due to that the isospectral processing is for a two-dimensional signals, i.e. a complex signals, such as generating an isospectral signal of a single side notch.

In this way, as a two-dimensional isospectral signal of a single side notch may be generated, the isospectral processing may be used in more applications, such as measurement of noises in a nonlinear system.

FIG. 14 is a schematic diagram of an isospectral processing method of Embodiment 1 of this disclosure. As shown in FIG. 14, the method includes:

operation 1401: adjusting a spectrum of a two-dimensional perturbation signal, so that a spectral difference between a spectrum of the adjusted signal and the target spectrum is smaller than that before the adjustment; and

operation 1402: performing inverse time-frequency domain transform on the signal with the adjusted spectrum, and transforming the signal with the adjusted spectrum from a frequency domain to a time domain to obtain a two-dimensional isospectral signal.

In addition, in some embodiments, the operation of perturbation processing may be omitted, in which case the isospectral processing may further include above operations 1301 and 1302.

It can be seen from the above embodiment that at least one time of equiprobability processing, perturbation processing and isospectral processing is performed on a two-dimensional input signal according to the two-dimensional dispersion signal based on the two-dimensional reference signal, and in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution. In this way, both the I-path signal and the Q-path signal have specific probability distribution, and the correlation between the I-path signal and the Q-path signal may be kept, thereby obtaining a two-dimensional isospectral equiprobability signal satisfying the required joint probability distribution and joint probability density function, and the method is applicable to various scenarios.

### Embodiment 2

The embodiment of this disclosure provides a signal generation method.

In some embodiments, the signal generation method may be applied to an input end of a communication system or a nonlinear system.

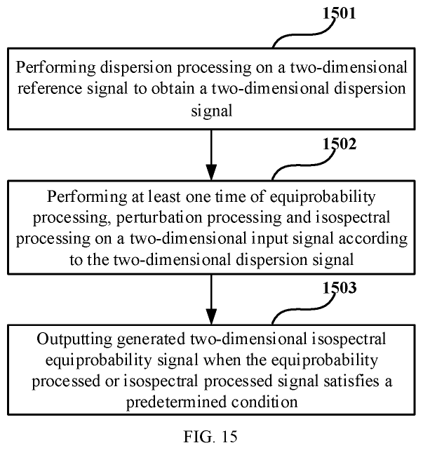

FIG. 15 is schematic diagram of the signal generation method of Embodiment 2 of this disclosure. As shown in FIG. 15, the method includes:

operation 1501: performing dispersion processing on a two-dimensional reference signal to obtain a two-dimensional dispersion signal;

operation 1502: performing at least one time of equiprobability processing, perturbation processing and isospectral processing on a two-dimensional input signal according to the two-dimensional dispersion signal; and

operation 1503: outputting generated two-dimensional isospectral equiprobability signal when the equiprobability processed or isospectral processed signal satisfies a predetermined condition,

wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain an equiprobability signal.

In this way, in the equiprobability processing, the two-dimensional dispersion signal and the two-dimensional reference signal are decomposed first, amplitude sorting, amplitude replacement and time sorting are respectively performed on the I-path signal and Q-path signal obtained after decomposition, and the I-path signal and Q-path signal obtained after the time sorting are combined to obtain the equiprobability signal. Hence, a two-dimensional isospectral equiprobability signal having I-path signal and Q-path signal with specific probability distribution and having joint probability distribution may be obtained.

Similar to Embodiment 1, in some embodiments, the performing at least one time of equiprobability processing, perturbation processing and isospectral processing on a two-dimensional input signal refers to performing equiprobability processing, perturbation processing and isospectral processing in an iterative manner, and the iteration is stopped and a signal is outputted until a predetermined condition is satisfied. In other words, an iterative process includes one time of equiprobability processing, one time of perturbation processing and one time of isospectral processing.

In some embodiments, after one time of iteration, that is, after one time of equiprobability processing, perturbation processing and isospectral processing, whether the predetermined condition is satisfied is determined after isospectral processing in a next iteration process, if the predetermined condition is satisfied, the signal is outputted, and if the predetermined condition is not satisfied, the next iteration process is proceeded. Reference may be made to FIG. 2 in Embodiment 1 for a specific process.

In some embodiments, after one time of iteration, that is, after one time of equiprobability processing, perturbation processing and isospectral processing, whether the predetermined condition is satisfied may be determined after the isospectral processing, or after equiprobability processing in the next iteration process, if the predetermined condition is satisfied, the signal is outputted, and if the predetermined condition is not satisfied, remaining processing in this time of iteration is continued and the next iteration process is proceeded. Reference may be made to FIG. 3 in Embodiment 1 for a specific process.

A specific equiprobability processing method in Embodiment 2 is different from that in Embodiment 1, and other operations are identical to those Embodiment 1, which shall not be repeated herein any further.

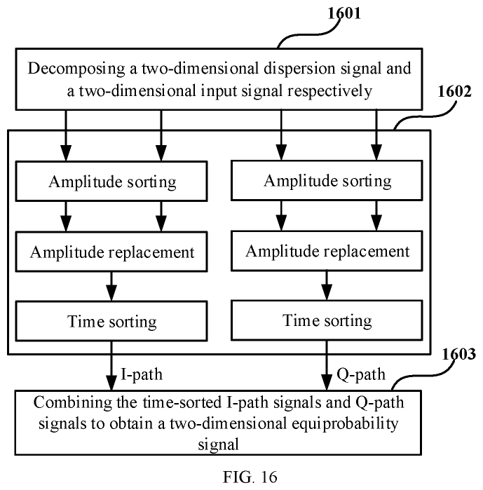

FIG. 16 is a schematic diagram of the equiprobability processing method of Embodiment 2 of this disclosure. As shown in FIG. 16, the method includes:

operation 1601: decomposing a two-dimensional dispersion signal and a two-dimensional input signal respectively;

operation 1602: performing amplitude sorting, amplitude replacement and time sorting on an I-path signal and Q-path signal of the decomposed two-dimensional dispersion signal and an I-path signal and Q-path signal of the decomposed two-dimensional reference signal; and

operation 1603: combining the time-sorted I-path signals and Q-path signals to obtain a two-dimensional equiprobability signal.

In operation 1601, the decomposing a two-dimensional dispersion signal and a two-dimensional input signal respectively is decomposing the two-dimensional dispersion signal into an I-path dispersion signal and a Q-path dispersion signal, and decomposing the two-dimensional input signal into an I-path input signal and a Q-path input signal.

In operation 1602, amplitude sorting, amplitude replacement and time sorting are performed on the I-path dispersion signal and the I-path input signal, and amplitude sorting, amplitude replacement and time sorting are performed on the Q-path dispersion signal and the Q-path input signal.

In some embodiments, in the amplitude sorting, the I-path input signal and the I-path dispersion signal may be sorted according to magnitudes of amplitudes of their respective data samples, such as sorting in a descending order, and time position coordinates of the data samples of the input signal in an original signal sequence after being sorted in an ascending or descending order of the amplitudes may be recorded; likewise, the Q-path input signal and the Q-path dispersion signal are sorted according to magnitudes of amplitudes if their respective data samples. The two-dimensional input signal and the two-dimensional dispersion signal are sorted in the same manner, such as sorting in an order of the magnitudes of the amplitudes of the data samples in a descending order, or sorting in an order of the magnitudes of the amplitudes of the data samples in an ascending order.

In some embodiments, in the amplitude replacement, amplitudes of the data samples of the sorted I-path input signal may be replaced with amplitudes of the data samples of the sorted I-path dispersion signal. Likewise, amplitudes of the data samples of the sorted Q-path input signal may be replaced with amplitudes of the data samples of the sorted Q-path dispersion signal.

In some embodiments, in the time sorting, all data samples may be resorted sequentially according to the recorded time position coordinates of the I-path input signal after the amplitude replacement, and the resorted signal is the I-path equiprobability signal. Likewise, all data samples may be resorted sequentially according to the recorded time position coordinates of the Q-path input signal after the amplitude replacement, and the resorted signal is the Q-path equiprobability signal.

In operation 1603, the I-path equiprobability signal and the Q-path equiprobability signal are combined into a two-dimensional equiprobability signal.

In some embodiments, for a case where a training sequence and a pilot symbol are inserted into the two-dimensional reference signal, time position locking is performed before the amplitude sorting. In this way, by locking the data samples (pilot symbols or training sequences) at specific time positions in the two-dimensional input signal and the two-dimensional reference signal, it may bed ensure that specific pilot symbols or training sequences are at these specific time positions.

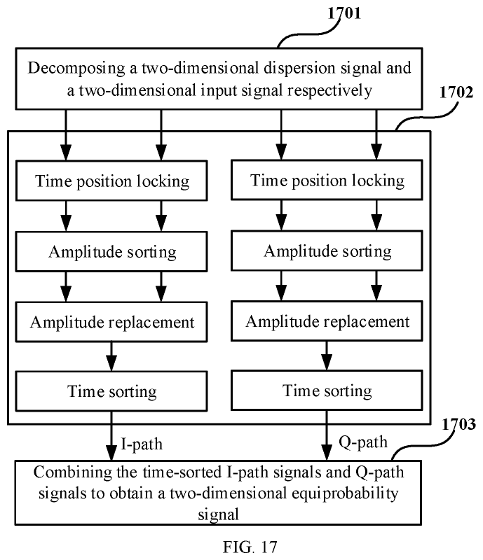

FIG. 17 is another schematic diagram of the equiprobability processing method of Embodiment 2 of this disclosure. As shown in FIG. 17, the method comprises:

operation 1701: decomposing a two-dimensional dispersion signal and a two-dimensional input signal respectively;

operation 1702: performing time position locking, amplitude sorting, amplitude replacement and time sorting on an I-path signal and Q-path signal of the decomposed two-dimensional dispersion signal and an I-path signal and Q-path signal of the decomposed two-dimensional reference signal; and

operation 1703: combining the time-sorted I-path signals and Q-path signals to obtain a two-dimensional equiprobability signal.

Reference may be made to the disclosure contained in Embodiment 1 for contents in Embodiment 2 that are identical to those in Embodiment 1, which shall not be repeated herein any further.

It can be seen from the above embodiment that at least one time of equiprobability processing, perturbation processing and isospectral processing is performed on a two-dimensional input signal according to the two-dimensional dispersion signal based on the two-dimensional reference signal, in the equiprobability processing, the two-dimensional dispersion signal and the two-dimensional input signal are decomposed first, amplitude sorting, amplitude replacement and time sorting are respectively performed on the decomposed I-path signals and Q-path signals, and the time sorted I-path signals and Q-path signals are combined to obtain the equiprobability signal. In this way, a two-dimensional isospectral equiprobability signal having I-path signal and Q-path signal with specific probability distribution and having joint probability distribution may be obtained.

### Embodiment 3

The embodiment of this disclosure provides a measurement method for nonlinear system noises.

In some embodiments, the nonlinear system is, for example, an optical communication system, or part of an optical communication system.

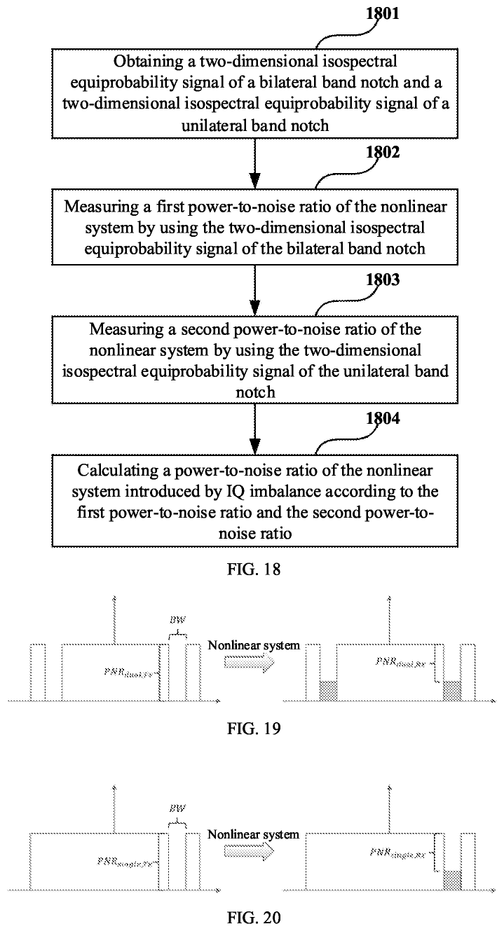

FIG. 18 is a schematic diagram of the measurement method for nonlinear system noises of Embodiment 3 of this disclosure. As shown in FIG. 18, the method includes:

operation 1801: obtaining a two-dimensional isospectral equiprobability signal of a bilateral band notch and a two-dimensional isospectral equiprobability signal of a unilateral band notch, the two-dimensional isospectral equiprobability signal of the bilateral band notch and the two-dimensional isospectral equiprobability signal of the unilateral band notch being generated in the signal generation method described in Embodiment 1 or 2;

operation 1802: measuring a first power-to-noise ratio (PNR) of the nonlinear system by using the two-dimensional isospectral equiprobability signal of the bilateral band notch;

operation 1803: measuring a second power-to-noise ratio of the nonlinear system by using the two-dimensional isospectral equiprobability signal of the unilateral band notch; and

operation 1804: calculating a power-to-noise ratio of the nonlinear system introduced by IQ imbalance according to the first power-to-noise ratio and the second power-to-noise ratio.

In some embodiments, an order of execution of operations 1802 and 1803 is not limited. In some embodiments, with the isospectral processing in the signal generation method described in Embodiment 1 or 2, the two-dimensional isospectral equiprobability signal of the bilateral band notch may be generated, and the two-dimensional isospectral equiprobability signal of the unilateral band notch may also be generated, and furthermore, I-path signals and Q-path signals of the two-dimensional isospectral equiprobability signal of the bilateral band notch and the two-dimensional isospectral equiprobability signal of the unilateral band notch have specific probability distributions and joint spectral distributions.

In operation 1802, the first power-to-noise ratio of the nonlinear system is measured by using the two-dimensional isospectral equiprobability signal of the bilateral band notch.

For example, the two-dimensional isospectral equiprobability signal of the bilateral band notch is inputted into a nonlinear system to be measured, and a signal power spectrum outputted by the nonlinear system is measured.

In some embodiments, the signal power spectrum may be measured by a spectrometer; or, the signal power spectrum may be calculated in receiver digital signal processing by using fast Fourier transform.

FIG. 19 is a schematic diagram of the power spectrum of the signal of the bilateral band notch after passing through the nonlinear system of Embodiment 3 of this disclosure.

As shown in FIG. 19, a nonlinear effect of nonlinear system may cause an input signal to generate a new frequency component, the frequency component being able to be observed within a band notch bandwidth. As a nonlinear noise and an additive white Gaussian noise (AWGN) are unable to be directly distinguished in spectra, average power P_{dual noise}(f) measured within a bilateral band notch bandwidth is a sum of nonlinear noise power and additive white Gaussian noise power. In addition, BW denotes the band notch bandwidth, PNR_{dual,Tx}(f) denotes power-to-noise ratio of an input signal of the nonlinear system, and PNR_{dual,Rx}(f) denotes power-to-noise ratio of an output signal of the nonlinear system.

For example, the power-to-noise ratio of the output signal of the nonlinear system, i.e. a first power-to-noise ratio, may be calculated according to the following formula (4) in the case of the two-dimensional isospectral equiprobability signal of the bilateral band notch:

$${PNR}_{dual , Rx} ( f ) = \frac{{P}_{dual signal} ( f )}{{P}_{dual noise} ( f )} = \frac{( {P ( f )}_{f ∈ {B}_{signal}} )}{( {P ( f )}_{f ∈ {B}_{nosie}} )} ; \qquad ( 4 )$$

where, f is a frequency, P(f) is the measured signal power spectrum, PNR_{dual,Rx}(f) denotes the power-to-noise ratio of the output signal of the nonlinear system, i.e. the first power-to-noise ratio, in the case of the two-dimensional isospectral equiprobability signal of the bilateral band notch, P_{dual signal}(f) denotes signal average power adjacent to the band notch bandwidth, (·) is an averaging operation, B_{signal}=[f_{c}−5BW/4,f_{c}−3BW/4] U [f_{c}+3BW/4, f_{c}+5BW/4], which is a calculated bandwidth of P_{dual signal}(f), Bₙₒᵢₛₑ=[f_{c}−BW/4, f_{c}+BW/4], which is a calculated bandwidth of P_{dual noise}(f), f_{c} is a band notch center frequency, and BW is the band notch bandwidth.

In operation 1803, the second power noise ratio of the nonlinear system is measured by using the two-dimensional isospectral equiprobability signal of the unilateral band notch.

For example, the two-dimensional isospectral equiprobability signal of the unilateral band notch is inputted into the nonlinear system to be measured to measure the signal power spectrum outputted by the nonlinear system.

In some embodiments, the signal power spectrum may be measured by a spectrometer; or, the signal power spectrum may be calculated in receiver digital signal processing by using fast Fourier transform.

FIG. 20 is a schematic diagram of the power spectrum of the signal of the unilateral band notch after passing through the nonlinear system of Embodiment 3 of this disclosure.

As shown in FIG. 20, IQ imbalance in the nonlinear system may destroy a frequency domain condition of the unilateral band notch. Therefore, the average power P_{single noise}(f) measured within the unilateral band notch bandwidth includes not only nonlinear noise power and additive Gaussian white noise power, but also contribution of the IQ imbalance. In addition, BW denotes the band notch bandwidth, PNR_{single,Tx}(f) denotes the power-to-noise ratio of the input signal of the nonlinear system, and PNR_{single,Rx}(f) denotes the power-to-noise ratio of the output signal of the nonlinear system.

For example, the power-to-noise ratio of the output signal of the nonlinear system, i.e. a second power-to-noise ratio, may be calculated according to the following formula (5) in the case of the two-dimensional isospectral equiprobability signal of the unilateral band notch:

$${PNR}_{single , Rx} ( f ) = \frac{{P}_{single signal} ( f )}{{P}_{single noise} ( f )} = \frac{( {P ( f )}_{f ∈ {B}_{signal}} )}{( {P ( f )}_{f ∈ {B}_{nosie}} )} ; \qquad ( 5 )$$

where, f is a frequency, P(f) is the measured signal power spectrum, PNR_{single,Rx}(f) denotes the power-to-noise ratio of the output signal of the nonlinear system, i.e. the second power-to-noise ratio, in the case of the two-dimensional isospectral equiprobability signal of the unilateral band notch, PNR_{single,Rx}(f) denotes signal average power adjacent to the band notch bandwidth, is an averaging operation, B_{signal}=[f_{c}−5BW/4, f_{c}−3BW/4] U [f_{c}+3BW/4, f_{c}+5BW/4], which is a calculated bandwidth of P_{single signal}(f), Bₙₒᵢₛₑ=[f_{c}−BW/4, f_{c}+BW/4], which is a calculated bandwidth of P_{single noise}(f), f_{c} is a band notch center frequency, and BW is the band notch bandwidth.

In some embodiments, the first power-to-noise ratio and the second power-to-noise ratio are calibrated when a band notch depth of the two-dimensional isospectral equiprobability signal of the bilateral band notch or the two-dimensional isospectral equiprobability signal of the unilateral band notch is less than or equal to a preset threshold. For example, the preset threshold is 25 dB.

For example, calibration may be performed according to the following formulae (6) and (7):

$$\frac{1}{{PNR}_{dual , Rx} ( f )} = \frac{1}{{PNR}_{dual , Rx} ( f )} - \frac{1}{{PNR}_{dual , Tx} ( f )} , \qquad ( 6 )$$

$$\frac{1}{{PNR}_{single , Rx} ( f )} = \frac{1}{{PNR}_{single , Rx}} - \frac{1}{{PNR}_{single , Tx} ( f )} ; \qquad ( 7 )$$

where, PNR_{dual,Rx}(f) and PNR_{single,Rx}(f) to the left of the equal sign respectively denote the first power-to-noise ratio and second power-to-noise ratio after being calibrated, PNR_{dual,Rx}(f) and PNR_{single,Rx}(f) to the right of the equal sign respectively denote the first power-to-noise ratio and second power-to-noise ratio before being calibrated, and PNR_{single,Tx}(f) respectively denote the power-to-noise ratio of the two-dimensional isospectral equiprobability signal of the bilateral band notch and the power-to-noise ratio of the two-dimensional isospectral equiprobability signal of the unilateral band notch inputted into the nonlinear system.

In operation 1804, the power-to-noise ratio introduced by IQ imbalance of the nonlinear system is calculated according to the first power-to-noise ratio and the second power-to-noise ratio.

As the average power P_{single noise}(f) measured within the unilateral band notch bandwidth includes not only nonlinear noise power and additive Gaussian white noise power, but also contribution of the IQ imbalance, and the average power P_{dual noise}(f) measured within the bilateral band notch bandwidth is the sum of the nonlinear noise power and additive Gaussian white noise power, the power-to-noise ratio introduced by the IQ imbalance may be calculated according to the first power-to-noise ratio obtained based on the bilateral band notch and the second power-to-noise ratio obtained based on the unilateral band notch.

For example, the power noise ratio introduced by the IQ imbalance may be calculated according to the following formula (8):

$$\frac{1}{{PNR}_{IQ imb} ( f )} = \frac{1}{{PNR}_{single , Rx}} - \frac{1}{{PNR}_{dual , Tx} ( f )} ; \qquad ( 8 )$$

wherein, PNR_{IQ imb}(f) denotes the power-to-noise ratio introduced by the IQ imbalance, PNR_{dual,Rx}(f) and PNR_{single,Rx}(f) respectively denote the first power-to-noise ratio and the second power-to-noise ratio.

In addition, in some embodiments, operations of the above formulae (4)-(8) are performed in linear units.

In some embodiments, for a case where a nonlinear effect occurs after carrier modulation, such as a nonlinear effect caused by a radio frequency power amplifier in wireless communications, first, similar to the above, the two-dimensional isospectral equiprobability signal with a unilateral band notch is generated according to Embodiment 1 or Embodiment 2, and then the output power spectrum of the nonlinear system is measured and a power-to-noise ratio is calculated by taking the two-dimensional isospectral equiprobability signal of the unilateral band notch as a test signal.

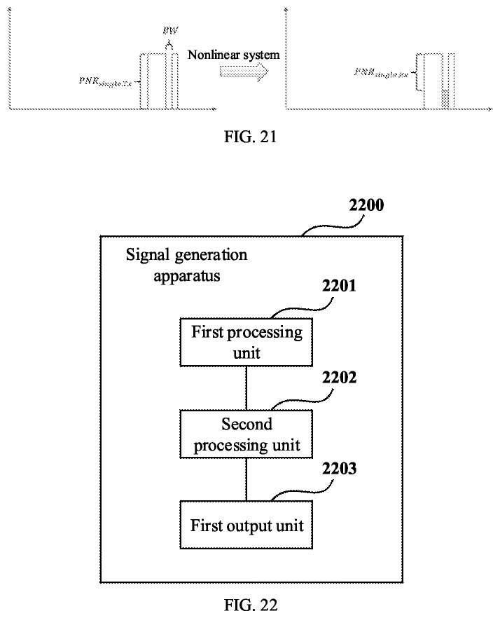

FIG. 21 is a schematic diagram of the power spectrum of the signal of the unilateral band notch after passing through the nonlinear system in the case where the nonlinear effect occurs after carrier modulation.

As shown in FIG. 21, the IQ imbalance in the nonlinear system may destroy a frequency domain condition of the unilateral band notch. Therefore, the average power P_{single noise}(f) measured within the unilateral band notch bandwidth includes not only nonlinear noise power and additive Gaussian white noise power, but also contribution of the IQ imbalance. Signal average power of an adjacent band notch bandwidth may be denoted by P_{single signal}(f), and the power-to-noise ratio PNR_{single,Rx}(f) of the nonlinear system may be obtained through calculation by using formula (5) above.

It can be seen from the above embodiment that by using the two-dimensional isospectral equiprobability signal of a bilateral band notch and two-dimensional isospectral equiprobability signal of a unilateral band notch obtained in the above methods, the first power-to-noise ratio and the second power-to-noise ratio of the nonlinear system may be respectively measured, thereby calculating the power-to-noise ratio of the nonlinear system introduced by the IQ imbalance. As the two-dimensional isospectral equiprobability signal of the bilateral band notch and two-dimensional isospectral equiprobability signal of the unilateral band notch obtained in the above methods are two-dimensional isospectral equiprobability signals having I-path signal and Q-path signal with specific probability distribution and having joint probability distribution, the power-to-noise ratios of the nonlinear system measured thereby are relatively high in accuracy.

### Embodiment 4

Embodiment 4 of this disclosure provides a signal generation apparatus. As a principle of the apparatus for solving problems is similar to that of the method of Embodiment 1, reference may be made to the implementation of the method described in Embodiment 1 for implementation of the apparatus, with identical or related contents being not going to be repeated herein any further.

FIG. 22 is a schematic diagram of the signal generation apparatus of Embodiment 4 of this disclosure. As shown in FIG. 22, a signal generation apparatus 2200 includes:

a first processing unit 2201 configured to perform dispersion processing on a two-dimensional reference signal to obtain a two-dimensional dispersion signal;

a second processing unit 2202 configured to perform at least one time of equiprobability processing, perturbation processing and isospectral processing on a two-dimensional input signal according to the two-dimensional dispersion signal; and

a first output unit 2203 configured to output generated a two-dimensional isospectral equiprobability signal when the equiprobability processed or the isospectral processed signal satisfies a predetermined condition,

wherein in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution.

Reference may be made to related contents in Embodiment 1 for particular functions of the above units, which shall not be described herein any further.

It can be seen from the above embodiment that at least one time of equiprobability processing, perturbation processing and isospectral processing is performed on a two-dimensional input signal according to the two-dimensional dispersion signal based on the two-dimensional reference signal, and in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution. In this way, both the I-path signal and the Q-path signal have specific probability distribution, and the correlation between the I-path signal and the Q-path signal may be kept, thereby obtaining a two-dimensional isospectral equiprobability signal satisfying the required joint probability distribution and joint probability density function, and the method is applicable to various scenarios.

### Embodiment 5

Embodiment 5 of this disclosure provides a signal generation apparatus. As a principle of the apparatus for solving problems is similar to that of the method of Embodiment 2, reference may be made to the implementation of the method described in Embodiment 2 for implementation of the apparatus, with identical or related contents being not going to be repeated herein any further.

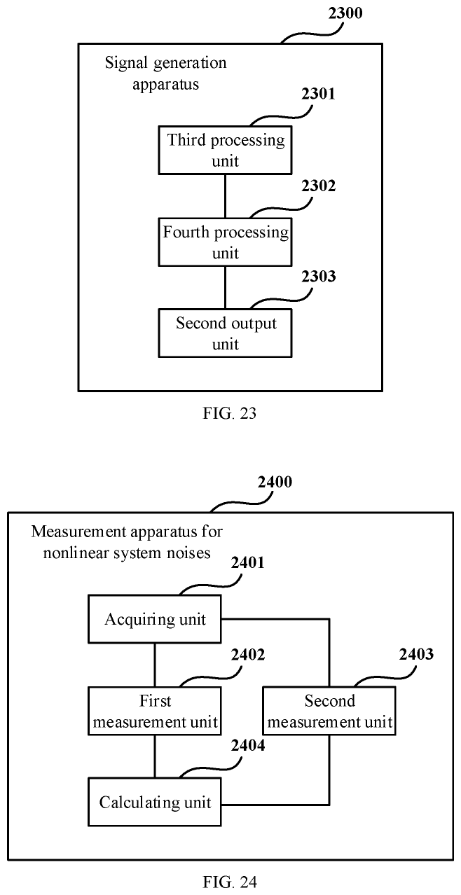

FIG. 23 is a schematic diagram of the signal generation apparatus of Embodiment 5 of this disclosure. As shown in FIG. 23, a signal generation apparatus 2300 includes:

a third processing unit 2301 configured to perform dispersion processing on a two-dimensional reference signal to obtain a two-dimensional dispersion signal;

a fourth processing unit 2302 configured to perform at least one time of equiprobability processing, perturbation processing and isospectral processing on a two-dimensional input signal according to the two-dimensional dispersion signal; and

a second output unit 2303 configured to output generated two-dimensional isospectral equiprobability signal when the equiprobability processed or isospectral processed signal satisfies a predetermined condition,

wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

Reference may be made to related contents in Embodiment 2 for particular functions of the above units, which shall not be described herein any further.

It can be seen from the above embodiment that at least one time of equiprobability processing, perturbation processing and isospectral processing is performed on a two-dimensional input signal according to the two-dimensional dispersion signal based on the two-dimensional reference signal, in the equiprobability processing, the two-dimensional dispersion signal and the two-dimensional input signal are decomposed first, amplitude sorting, amplitude replacement and time sorting are respectively performed on the decomposed I-path signals and Q-path signals, and the time sorted I-path signals and Q-path signals are combined to obtain the equiprobability signal. In this way, a two-dimensional isospectral equiprobability signal having I-path signal and Q-path signal with specific probability distribution and having joint probability distribution may be obtained.

### Embodiment 6

Embodiment 6 of this disclosure provides a measurement apparatus for nonlinear system noises. As a principle of the apparatus for solving problems is similar to that of the method of Embodiment 3, reference may be made to the implementation of the method described in Embodiment 3 for implementation of the apparatus, with identical or related contents being not going to be repeated herein any further.

FIG. 24 is a schematic diagram of the measurement apparatus for nonlinear system noises of Embodiment 6 of this disclosure. As shown in FIG. 24, a measurement apparatus 2400 for nonlinear system noises includes:

an acquiring unit 2401 configured to acquire two-dimensional isospectral equiprobability signal of a bilateral band notch and two-dimensional isospectral equiprobability signal of a unilateral band notch, the two-dimensional isospectral equiprobability signal of the bilateral band notch and the two-dimensional isospectral equiprobability signal of the unilateral band notch being generated by the signal generation apparatus as described in Embodiment 4 or Embodiment 5;

a first measurement unit 2402 configured to measure a first power-to-noise ratio of the nonlinear system by using the two-dimensional isospectral equiprobability signal of the bilateral band notch;

a second measurement unit 2403 configured to measure a second power-to-noise ratio of the nonlinear system by using the two-dimensional isospectral equiprobability signal of the unilateral band notch; and

a calculating unit 2404 configured to calculate a power-to-noise ratio of the nonlinear system introduced by IQ imbalance according to the first power-to-noise ratio and the second power-to-noise ratio.

Reference may be made to related contents in Embodiment 3 for particular functions of the above units, which shall not be described herein any further.

It can be seen from the above embodiment that by using the two-dimensional isospectral equiprobability signal of a bilateral band notch and two-dimensional isospectral equiprobability signal of a unilateral band notch obtained in the above methods, the first power-to-noise ratio and the second power-to-noise ratio of the nonlinear system may be respectively measured, thereby calculating the power-to-noise ratio of the nonlinear system introduced by the IQ imbalance. As the two-dimensional isospectral equiprobability signal of the bilateral band notch and two-dimensional isospectral equiprobability signal of the unilateral band notch obtained in the above methods are two-dimensional isospectral equiprobability signals having I-path signal and Q-path signal with specific probability distribution and having joint probability distribution, the power-to-noise ratios of the nonlinear system measured thereby are relatively high in accuracy.

### Embodiment 7

The embodiment of this disclosure provides an electronic device. FIG. 25 is a schematic diagram of the electronic device of Embodiment 7 of this disclosure. As shown in FIG. 25, an electronic device 2500 includes a signal generating apparatus 2501 and/or a measurement apparatus 2502 for nonlinear system noises. A structure and function of the signal generating apparatus 2501 are identical to those described in Embodiment 4 or Embodiment 5, and a structure and function of the measurement apparatus 2502 for nonlinear system noises are identical to those described in Embodiment 6, which shall not be described herein any further.

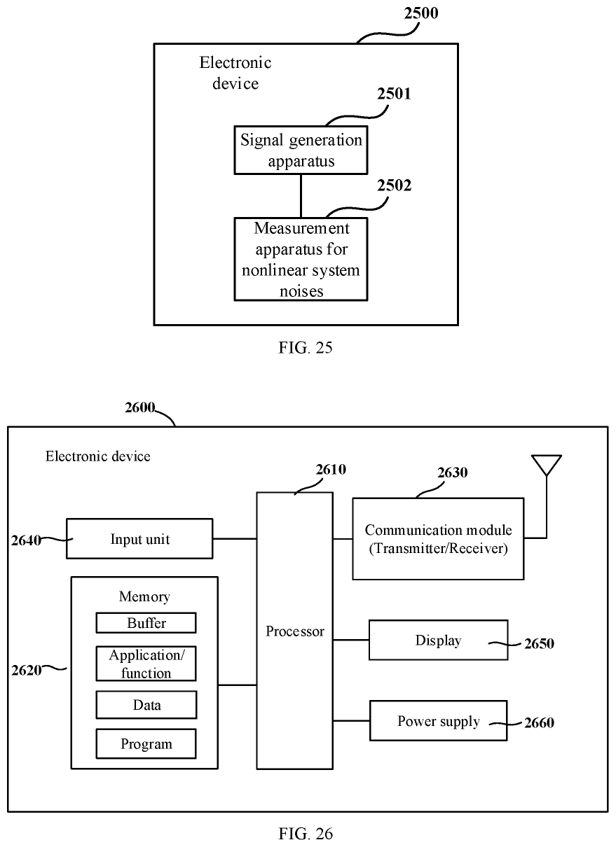

FIG. 26 is a block diagram of a systematic structure of the electronic device of Embodiment 7 of this disclosure. As shown in FIG. 26, an electronic device 2600 may include a processor 2601 and a memory 2602, the memory 2602 being coupled to the processor 2601. This figure is illustrative only, and other types of structures may also be used, so as to supplement or replace this structure and achieve a telecommunications function or other functions.

As shown in FIG. 26, the electronic device 2600 may further include an input unit 2603, a display 2604 and a power supply 2605.

In one implementation, the functions of the signal generation apparatus described in Embodiment 4 may be integrated into the processor 2601. The processor 2601 may be configured to: perform at least one time of equiprobability processing, perturbation processing and isospectral processing on a two-dimensional input signal according to the two-dimensional dispersion signal; and output generated a two-dimensional isospectral equiprobability signal when the equiprobability processed or the isospectral processed signal satisfies a predetermined condition, wherein in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution.

For example, the equiprobability processing includes: classifying the two-dimensional dispersion signal and the two-dimensional input signal, so that numbers of constellation points of the two-dimensional input signal and the two-dimensional dispersion signal of the same class are identical; in each class, sorting the two-dimensional input signal and the two-dimensional dispersion signal respectively; in each class, replacing the two-dimensional input signal with the two-dimensional dispersion signal; and recovering the replaced two-dimensional input signal to be of original time position coordinates, so as to obtain the equiprobability processed signal.

For example, the classifying the two-dimensional dispersion signal and the two-dimensional input signal, so that numbers of constellation points of the two-dimensional input signal and the two-dimensional dispersion signal of the same class are identical, includes: classifying the two-dimensional dispersion signal into M classes by using a decision field to which the two-dimensional reference signal correspond, and counting the number of constellation points of the two-dimensional dispersion signal in each class; and sorting and classifying the two-dimensional input signal into M classes by amplitudes and/or phases, so that the number of constellation points of the two-dimensional input signal in the same class is identical to the number of constellation points of the two-dimensional dispersion signal; where, M is a positive integer.

For example, the sorting the two-dimensional input signal and the two-dimensional dispersion signal respectively includes: sorting the two-dimensional input signal and the two-dimensional dispersion signal respectively by modulo values, or, sorting the two-dimensional input signal and the two-dimensional dispersion signal respectively by angles.

For example, the replacing the two-dimensional input signal with the two-dimensional dispersion signal includes: directly replacing the two-dimensional input signal with the two-dimensional dispersion signal; or, replacing the two-dimensional input signal one by one with the two-dimensional dispersion signal by using a minimum Euclidean distance as a criterion.

For example, the equiprobability processing further includes: for a case where a training sequence and a pilot symbol are inserted into the two-dimensional reference signal, performing time position locking before the classifying processing.

For example, in the perturbation processing, a perturbation amplitude is variable.

For example, a perturbation amplitude of current perturbation processing decreases in comparison with previous perturbation processing.

For example, the isospectral processing includes unilateral isospectral processing and bilateral isospectral processing.

In another implementation, the functions of the signal generation apparatus described in Embodiment 5 may be integrated into the processor 2601. The processor 2601 may be configured to: perform dispersion processing on a two-dimensional reference signal to obtain a two-dimensional dispersion signal; perform at least one time of equiprobability processing, perturbation processing and isospectral processing on a two-dimensional input signal according to the two-dimensional dispersion signal; and output generated two-dimensional isospectral equiprobability signal when the equiprobability processed or isospectral processed signal satisfies a predetermined condition, wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

In a further implementation, the functions of the measurement apparatus for nonlinear system noises described in Embodiment 6 may be integrated into the processor 2601. The processor 2601 may be configured to: acquire two-dimensional isospectral equiprobability signal of a bilateral band notch and two-dimensional isospectral equiprobability signal of a unilateral band notch, the two-dimensional isospectral equiprobability signal of the bilateral band notch and the two-dimensional isospectral equiprobability signal of the unilateral band notch being generated by the signal generation apparatus as described in Embodiment 1 or Embodiment 2; measure a first power-to-noise ratio of the nonlinear system by using the two-dimensional isospectral equiprobability signal of the bilateral band notch; measure a second power-to-noise ratio of the nonlinear system by using the two-dimensional isospectral equiprobability signal of the unilateral band notch; and calculate a power-to-noise ratio of the nonlinear system introduced by IQ imbalance according to the first power-to-noise ratio and the second power-to-noise ratio.

Furthermore, the signal generating apparatus described in Embodiment 4 or Embodiment 5 or the measurement apparatus for nonlinear system noises described in Embodiment 6 and the processor 2601 may be configured separately. For example, the signal generating apparatus or the measurement apparatus for nonlinear system noises may be configured as a chip connected to the processor 2601, and the function of the signal generating apparatus or the measurement apparatus for nonlinear system noises may be implemented under control of the processor 2001.

In this embodiment, the electronic device 2600 does not necessarily include all components shown in FIG. 26.

As shown in FIG. 26, the processor 2601 is sometimes referred to as a controller or an operational control, which may include a microprocessor or other processor devices and/or logic devices. The processor 2601 receives input and controls operations of components of the electronic device 2600.

The memory 2602 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 2601 may execute programs stored in the memory 2602, so as to realize information storage or processing, etc. Functions of other parts are similar to those of the related art, which shall not be described herein any further. The parts of the terminal equipment 2600 may be realized by specific hardware, firmware, software, or any combination thereof, without departing from the scope of this disclosure.

In this embodiment, the electronic device may be a stand-alone device, such as a stand-alone computer, or, it may also be integrated in an optical receiver.

It can be seen from the above embodiment that at least one time of equiprobability processing, perturbation processing and isospectral processing is performed on a two-dimensional input signal according to the two-dimensional dispersion signal, and in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintains joint probability distribution. In this way, both the I-path signal and the Q-path signal have specific probability distribution, and the correlation between the I-path signal and the Q-path signal may be kept, thereby obtaining a two-dimensional isospectral equiprobability signal satisfying the required joint probability distribution and joint probability density function, and the method is applicable to various scenarios.

Or, in equiprobability processing, the two-dimensional dispersion signal and the two-dimensional input signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal. In this way, a two-dimensional isospectral equiprobability signal having I-path signal and Q-path signal with specific probability distribution and having joint probability distribution may be obtained.

Furthermore, by using the two-dimensional isospectral equiprobability signal of a bilateral band notch and two-dimensional isospectral equiprobability signal of a unilateral band notch obtained in the above methods, the first power-to-noise ratio and the second power-to-noise ratio of the nonlinear system may be respectively measured, thereby calculating the power-to-noise ratio of the nonlinear system introduced by IQ imbalance. As the two-dimensional isospectral equiprobability signal of a bilateral band notch and two-dimensional isospectral equiprobability signal of a unilateral band notch obtained in the above methods are two-dimensional isospectral equiprobability signals having I-path signal and Q-path signal with specific probability distribution and having joint probability distribution, the power-to-noise ratios of the nonlinear system measured thereby are relatively high in accuracy.

An embodiment of this disclosure provides a computer readable program, which, when executed in a signal generation apparatus or an electronic device, will cause a computer to carry out the signal generation method as described in Embodiment 1 or Embodiment 2 in the signal generation apparatus or the electronic device.

An embodiment of this disclosure provides a computer readable medium, including a computer readable program, which will cause a computer to carry out the measurement method for nonlinear system noises as described in Embodiment 1 or Embodiment 2 in a signal generation apparatus or an electronic device.

An embodiment of this disclosure provides a computer readable program, which, when executed in a measurement apparatus for nonlinear system noises or an electronic device, will cause a computer to carry out the measurement method for nonlinear system noises as described in Embodiment 3 in the measurement apparatus for nonlinear system noises or the electronic device.

An embodiment of this disclosure provides a computer readable medium, including a computer readable program, which will cause a computer to carry out the measurement method for nonlinear system noises as described in Embodiment 3 in a measurement apparatus for nonlinear system noises or an electronic device.

The signal generation method carried out in the signal generation apparatus or the electronic device described with reference to the embodiments of this disclosure may be directly embodied as hardware, software modules executed by a processor, or a combination thereof. For example, one or more functional block diagrams and/or one or more combinations of the functional block diagrams shown FIG. 22 may either correspond to software modules of procedures of a computer program, or correspond to hardware modules. Such software modules may respectively correspond to the operations shown in FIG. 1. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 22 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 22 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

According to the implementations disclosed in the embodiments of this disclosure, following supplements are further disclosed.

In an example, a signal generation apparatus may include:

a first processing unit configured to perform dispersion processing on a two-dimensional reference signal to obtain a two-dimensional dispersion signal;

a second processing unit configured to perform at least one time of equiprobability processing, perturbation processing and isospectral processing on a two-dimensional input signal according to the two-dimensional dispersion signal; and

a first output unit configured to output generated a two-dimensional isospectral equiprobability signal when the equiprobability processed or the isospectral processed signal satisfies a predetermined condition,

wherein in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution.

In an example, according to the apparatus according to supplement 1, wherein the equiprobability processing comprises:

classifying the two-dimensional dispersion signal and the two-dimensional input signal, so that numbers of constellation points of the two-dimensional input signal and the two-dimensional dispersion signal of the same class are identical;

in each class, sorting the two-dimensional input signal and the two-dimensional dispersion signal respectively;

in each class, replacing the two-dimensional input signal with the two-dimensional dispersion signal; and

recovering the replaced two-dimensional input signal to be of original time position coordinates, so as to obtain the equiprobability processed signal.

In an example, according to the apparatus according to supplement 2, wherein the classifying the two-dimensional dispersion signal and the two-dimensional input signal, so that numbers of constellation points of the two-dimensional input signal and the two-dimensional dispersion signal of the same class are identical, comprises:

classifying the two-dimensional dispersion signal into M classes by using a decision field to which the two-dimensional reference signal correspond, and counting the number of constellation points of the two-dimensional dispersion signal in each class; and

sorting and classifying the two-dimensional input signal into M classes by amplitudes and/or phases, so that the number of constellation points of the two-dimensional input signal in the same class is identical to the number of constellation points of the two-dimensional dispersion signal;

where, M is a positive integer.

In an example, according to the The apparatus according to supplement 2, wherein the sorting the two-dimensional input signal and the two-dimensional dispersion signal respectively comprises:

sorting the two-dimensional input signal and the two-dimensional dispersion signal respectively by modulo values, or, sorting the two-dimensional input signal and the two-dimensional dispersion signal respectively by angles.

In an example, according to the The apparatus according to supplement 2, wherein the replacing the two-dimensional input signal with the two-dimensional dispersion signal comprises:

directly replacing the two-dimensional input signal with the two-dimensional dispersion signal; or,

replacing the two-dimensional input signal one by one with the two-dimensional dispersion signal by using a minimum Euclidean distance as a criterion.

In an example, according to the The apparatus according to supplement 2, wherein the equiprobability processing further comprises:

for a case where a training sequence and a pilot symbol are inserted into the two-dimensional reference signal, performing time position locking before the classifying processing.

In an example, according to the apparatus according to supplement 1, wherein,

in the perturbation processing, a perturbation amplitude is variable.

8. The apparatus according to supplement 1, wherein,

a perturbation amplitude of current perturbation processing decreases in comparison with previous perturbation processing.

In an example, according to the apparatus according to supplement 1, wherein,

the isospectral processing comprises unilateral isospectral processing and bilateral isospectral processing.

In an example, according to a signal generation apparatus, wherein the apparatus comprises:

a third processing unit configured to perform dispersion processing on a two-dimensional reference signal to obtain a two-dimensional dispersion signal;

a fourth processing unit configured to perform at least one time of equiprobability processing, perturbation processing and isospectral processing on a two-dimensional input signal according to the two-dimensional dispersion signal; and

a second output unit configured to output generated two-dimensional isospectral equiprobability signal when the equiprobability processed or isospectral processed signal satisfies a predetermined condition,

wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

In an example, according to the apparatus according to supplement 10, wherein,

in the perturbation processing, a perturbation amplitude is variable.

In an example, according to the apparatus according to supplement 10, wherein,

a perturbation amplitude of current perturbation processing decreases in comparison with previous perturbation processing.

In an example, according to the apparatus according to supplement 10, wherein,

the isospectral processing comprises unilateral isospectral processing and bilateral isospectral processing.

In an example, according to a measurement apparatus for nonlinear system noises, wherein the apparatus comprises:

an acquiring unit configured to acquire two-dimensional isospectral equiprobability signal of a bilateral band notch and two-dimensional isospectral equiprobability signal of a unilateral band notch, the two-dimensional isospectral equiprobability signal of the bilateral band notch and the two-dimensional isospectral equiprobability signal of the unilateral band notch being generated by the signal generation apparatus as described in any one of supplements 1-13;

a first measurement unit configured to measure a first power-to-noise ratio of the nonlinear system by using the two-dimensional isospectral equiprobability signal of the bilateral band notch;

a second measurement unit configured to measure a second power-to-noise ratio of the nonlinear system by using the two-dimensional isospectral equiprobability signal of the unilateral band notch; and

a calculating unit configured to calculate a power-to-noise ratio of the nonlinear system introduced by IQ imbalance according to the first power-to-noise ratio and the second power-to-noise ratio.

In an example, according to an electronic device, comprising the apparatus as described in any one of supplements 1-14.

In an example, according to a signal generation method, wherein the method comprises:

performing dispersion processing on a two-dimensional reference signal to obtain a two-dimensional dispersion signal;

performing at least one time of equiprobability processing, perturbation processing and isospectral processing on a two-dimensional input signal according to the two-dimensional dispersion signal; and

outputting generated a two-dimensional isospectral equiprobability signal when the equiprobability processed or the isospectral processed signal satisfies a predetermined condition,

wherein in the equiprobability processing, the two-dimensional dispersion signal and the two-dimensional input signal are classified, so that numbers of constellation points of the two-dimensional input signal and the two-dimensional dispersion signal of the same classes are identical, and the classified two-dimensional input signal and two-dimensional dispersion signal are sorted, so that the equiprobability processed signal maintain joint probability distribution.

In an example, according to the method according to supplement 16, wherein the equiprobability processing comprises:

classifying the two-dimensional dispersion signal and the two-dimensional input signal, so that numbers of constellation points of the two-dimensional input signal and the two-dimensional dispersion signal of the same class are identical;

in each class, sorting the two-dimensional input signal and the two-dimensional dispersion signal respectively;

in each class, replacing the two-dimensional input signal with the two-dimensional dispersion signal; and

recovering the replaced two-dimensional input signal to be of original time position coordinates, so as to obtain the equiprobability processed signal.

In an example, according to the method according to supplement 17, wherein the classifying the two-dimensional dispersion signal and the two-dimensional input signal, so that numbers of constellation points of the two-dimensional input signal and the two-dimensional dispersion signal of the same class are identical, comprises:

classifying the two-dimensional dispersion signal into M classes by using a decision field to which the two-dimensional reference signal correspond, and counting the number of constellation points of the two-dimensional dispersion signal in each class; and

sorting and classifying the two-dimensional input signal into M classes by amplitudes and/or phases, so that the number of constellation points of the two-dimensional input signal in the same class is identical to the number of constellation points of the two-dimensional dispersion signal;

where, M is a positive integer.

In an example, according to the method according to supplement 17, wherein the sorting the two-dimensional input signal and the two-dimensional dispersion signal respectively comprises:

sorting the two-dimensional input signal and the two-dimensional dispersion signal respectively by modulo values, or,

sorting the two-dimensional input signal and the two-dimensional dispersion signal respectively by angles.

In an example, according to the method according to supplement 17, wherein the replacing the two-dimensional input signal with the two-dimensional dispersion signal comprises:

directly replacing the two-dimensional input signal with the two-dimensional dispersion signal; or,

replacing the two-dimensional input signal one by one with the two-dimensional dispersion signal by using a minimum Euclidean distance as a criterion.

In an example, according to the method according to supplement 17, wherein the equiprobability processing further comprises:

for a case where a training sequence and a pilot symbol are inserted into the two-dimensional reference signal, performing time position locking before the classifying processing.

In an example, according to the method according to supplement 16, wherein, in the perturbation processing, a perturbation amplitude is variable.

In an example, according to the method according to supplement 22, wherein, a perturbation amplitude of current perturbation processing decreases in comparison with previous perturbation processing.

In an example, according to the method according to supplement 16, wherein, the isospectral processing comprises unilateral isospectral processing and bilateral isospectral processing.

In an example, according to a signal generation method, wherein the method comprises:

performing dispersion processing on a two-dimensional reference signal to obtain a two-dimensional dispersion signal;

performing at least one time of equiprobability processing, perturbation processing and isospectral processing on a two-dimensional input signal according to the two-dimensional dispersion signal; and

outputting generated two-dimensional isospectral equiprobability signal when the equiprobability processed or isospectral processed signal satisfies a predetermined condition,

wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

In an example, according to the method according to supplement 25, wherein,

in the perturbation processing, a perturbation amplitude is variable.

In an example, according to the method according to supplement 26, wherein,

a perturbation amplitude of current perturbation processing decreases in comparison with previous perturbation processing.

In an example, according to the method according to supplement 25, wherein,

the isospectral processing comprises unilateral isospectral processing and bilateral isospectral processing.

In an example, according to a measurement method for nonlinear system noises, wherein the method comprises:

obtaining a two-dimensional isospectral equiprobability signal of a bilateral band notch and a two-dimensional isospectral equiprobability signal of a unilateral band notch, the two-dimensional isospectral equiprobability signal of the bilateral band notch and the two-dimensional isospectral equiprobability signal of the unilateral band notch being generated by the signal generation method as described in any one of supplements 16-28;

measuring a first power-to-noise ratio of the nonlinear system by using the two-dimensional isospectral equiprobability signal of the bilateral band notch;

measuring a second power-to-noise ratio of the nonlinear system by using the two-dimensional isospectral equiprobability signal of the unilateral band notch; and
calculating a power-to-noise ratio of the nonlinear system introduced by IQ imbalance according to the first power-to-noise ratio and the second power-to-noise ratio.

What is claimed is:

1. A signal generation apparatus, comprising:
a memory; and
a processor coupled to the memory to control execution of a process to:
perform dispersion processing on a two-dimensional reference signal to obtain a two-dimensional dispersion signal;
perform at least one time of equiprobability processing, perturbation processing and isospectral processing on a two-dimensional input signal according to the two-dimensional dispersion signal; and
output a two-dimensional isospectral equiprobability signal generated, when an equiprobability processed signal according to the equiprobability processing or an isospectral processed signal according to the isospectral processing satisfies a predetermined condition,
wherein, in the equiprobability processing, the two-dimensional dispersion signal and the two-dimensional input signal are classified, so that numbers of constellation points of the two-dimensional input signal and the two-dimensional dispersion signal of same classes are identical, and the classified two-dimensional input signal and two-dimensional dispersion signal are sorted, so that the equiprobability processed signal maintain joint probability distribution.

2. The signal generation apparatus according to claim 1, wherein the equiprobability processing whereby the two-dimensional dispersion signal and the two-dimensional input signal are classified comprises:
in each class, sorting the two-dimensional input signal and the two-dimensional dispersion signal, respectively;
in each class, replacing the two-dimensional input signal with the two-dimensional dispersion signal; and
recovering the replaced two-dimensional input signal to be of original time position coordinates, so as to obtain the equiprobability processed signal.

3. The signal generation apparatus according to claim 2, wherein the classifying the two-dimensional dispersion signal and the two-dimensional input signal comprises:
classifying the two-dimensional dispersion signal into M classes by using a decision field to which the two-dimensional reference signal correspond, and counting a number of constellation points of the two-dimensional dispersion signal in each class; and
sorting and classifying the two-dimensional input signal into M classes by amplitudes and/or phases, so that a number of constellation points of the two-dimensional input signal in the same class is identical to the number of constellation points of the two-dimensional dispersion signal;
where, M is a positive integer.

4. The signal generation apparatus according to claim 2, wherein the sorting the two-dimensional input signal and the two-dimensional dispersion signal, respectively, comprises:
sorting the two-dimensional input signal and the two-dimensional dispersion signal respectively by modulo values, or,
sorting the two-dimensional input signal and the two-dimensional dispersion signal respectively by angles.

5. The signal generation apparatus according to claim 2, wherein the replacing the two-dimensional input signal with the two-dimensional dispersion signal comprises:
directly replacing the two-dimensional input signal with the two-dimensional dispersion signal; or,
replacing the two-dimensional input signal one by one with the two-dimensional dispersion signal by using a minimum Euclidean distance as a criterion.

6. The signal generation apparatus according to claim 2, wherein the equiprobability processing further comprises:
for a case where a training sequence and a pilot symbol are inserted into the two-dimensional reference signal, performing time position locking before the classifying.

7. The signal generation apparatus according to claim 1, wherein,
in the perturbation processing, a perturbation amplitude is variable.

8. The signal generation apparatus according to claim 1, wherein,
the isospectral processing comprises unilateral isospectral processing and bilateral isospectral processing.

9. A signal generation apparatus, comprising:
a memory; and
a processor coupled to the memory to control execution of a process to:
perform dispersion processing on a two-dimensional reference signal to obtain a two-dimensional dispersion signal;
perform at least one time of equiprobability processing, perturbation processing and isospectral processing on a two-dimensional input signal according to the two-dimensional dispersion signal; and
output generated two-dimensional isospectral equiprobability signal when an equiprobability processed signal according to the equiprobability processing or an isospectral processed signal according to the isospectral processing satisfies a predetermined condition,
wherein in the equiprobability processing, the two-dimensional dispersion signal and the two-dimensional reference signal are decomposed first, amplitude sorting, amplitude replacement and time sorting are respectively performed on I-path signal and Q-path signal obtained after decomposition, and I-path signal and Q-path signal obtained after the time sorting are combined to obtain a equiprobability signal.

10. A measurement apparatus for nonlinear system noises, comprising:
a memory; and
a processor coupled to the memory to control execution of a process to:
acquire two-dimensional isospectral equiprobability signal of a bilateral band notch and two-dimensional isospectral equiprobability signal of a unilateral band notch, the two-dimensional isospectral equiprobability signal of the bilateral band notch and the two-dimensional isospectral equiprobability signal of the unilateral band notch being generated by the signal generation apparatus as claimed in claim 1;
measure a first power-to-noise ratio of the nonlinear system by using the two-dimensional isospectral equiprobability signal of the bilateral band notch;
measure a second power-to-noise ratio of the nonlinear system by using the two-dimensional isospectral equiprobability signal of the unilateral band notch; and
calculate a power-to-noise ratio of the nonlinear system introduced by IQ imbalance according to the first power-to-noise ratio and the second power-to-noise ratio.
